(19) United States
(12) Patent Application Publication
(10) Pub. No.: US 2002/0080977 A1
(43) Pub. Date: Jun. 27, 2002

(54) Architecture for two-channel sound effect hardware to output four-channel analog signal and the method of the same

(76) Inventor: Chi-Chen Cheng, Taipei (TW)

Correspondence Address: Chun M. Ng, BLAKELY, SOKOLOFF, TAYLOR & ZAFMAN LLP, Seventh Floor, 12400 Wilshire Boulevard, Los Angeles, CA, 90025-1026, US

(21) Appl. No.: 09/819,139

(22) Filed: Mar. 27, 2001

(30) Foreign Application Priority Data
Dec. 27, 2000 (TW) 89128067

(51) Int. Cl. H04R 5/00

(52) U.S. Cl. 381/18; 381/22; 700/94

(57) ABSTRACT

An architecture allows two-channel sound effect hardware to output four-channel analog signal, comprising sound effect application program for processing multi-channel information of application software. An operation system kernel program is received the multi-channel information by a multi-channel sound effect interface. Means for transforming a four-channel signal to two-channel signal is coupled to the operation system kernel program to transform a four-channel information to a two-channel information. A two-channel sound effect hardware is coupled to the means for transforming a four-channel signal to two-channel signal. A converter is coupled to the two-channel sound effect hardware to transform the two-channel signal to a four-channel analog signal.

### FIELD OF THE INVENTION

The present invention relates to a multi-channel sound effect, and more specifically, to a method for two-channel sound effect hardware to output four-channel analog signal.

### BACKGROUND OF THE INVENTION

In recent years, the electronic industry is dramatically developed with a brisk step due to the improvement of the semiconductor industry and the wide spread of the computer and the communication techniques. The product towards to the trend of lighter weight, smaller size, multi-function and faster operation speed. Under such circumstances, the computer system has already become the standard tool to access the operation and the equipment for the personal entertainment. The DVD system implanted in the computer is widely spreading and driven by the development of the technology. Further, the 3D orientating sound effect has been implanted into the computer game to improve the entertainment effect. On the other hands, most of the PC exhibits the capability to play the DVD, the multi-sound effect therefore is implanted in the DVD system. Up to now, the orientating technique includes HRTF (Head Related Transfer Function) and Panning. HRTF uses the model of the human ear to find out the human how to determine the orientation of the sound source. There are three factors that influences the quality of the sound orientation, which are the sound amplitude difference between two human ears heard, the time difference between each ear heard the sound and the frequency response.

Basically, the ideal 3D orientating system includes an excellent HRTF Library and an excellent TCC to improve the sweet spot. Two speakers may create upper and lower, front and rear sound effect. Generally, the TCC is implanted in the system and the TCC is a kind of circuits used to eliminate interference for improving the output sound quality. However, the TCC is designed according to the HRTF Library used a fake human model for test. Therefore, it is unlikely to eliminate the interference completely due to the fake human model is somewhat different from the actual human heard. Further, the frequency response of a typical speaker for the PC is not good enough such that the interference can not be eliminated before the speaker outputs the signal, especially to the high frequency signal. Unfortunately, the high frequency signal is one of the factors for the human to distinguish where is the sound comes from. If the speaker has the serious problems of lack fidelity, the 3D sound effect is poor. The improved four-channel HRTF system may solve the problem. In the system, the acoustic field of the front and rear sound channel is generated by the HRTF system. The improved two-channel HRTF Library system may successively obtain the benefits of the four-channel HRTF system, the user may enjoy the smooth sweet spot generated by the system.

The other technique refers to Panning technique that involves the usage of IAD and ITD technology. The quality of the technology is acceptable.

Up to now, the current CPU has the capability of playing DVD and provides AC3 5.1 acoustic field output. AC3 includes six channels for providing sound effect with six sound sources. In the PC system, 4.1D speaker specification is designed for performing four-channel sound effect, the 4.1D includes four-channel and one super base speakers. The sound source of the heavy base rises from the disorientation low frequency component filtered by a low pass filter, the filtered low frequency is then fed to a base amplifier of a mono sound channel to drive the speaker. The heavy base information of the AC3 is transmitted to the two front-sound channel speakers. The 3D orientation that involves the four-channel as the kernel technique uses added rear speaker to improve the limitation of two speakers. This structure has become the standard equipment for the family theater. Therefore, the high-level PCI sound effect card is implanted with four-channel sound effect since 1999.

FIG. 1 illustrates a conventional architecture of a PCI high-level multi-channel sound effect software and hardware. In the diagram 100, the sound effect application program of application software is transmitted to the kernel program of an operation system 110 via high-level interface. The aforementioned application software includes 3D game, CD, MP3 display program or DVD multi-channel family theater display software. Beside, the operation system is well know in the art that includes MS window system, Linux, BeOS. One of the functions of the operation system is to construct standard sound effect interface.

Thereafter, in the block 120, above processed information or signal is transformed by using sound effect driver 120 via the low level interface to a multi-channel direct memory access (DMA) format which can be accepted by the hardware. Then, the accepted information is transmitted to the hardware such as PCI sound effect card 130 via PCI DMA. The PCI sound effect card 130 includes a multi-channel PCI sound effect hardware 140 and a multi-channel code and decode (CODEC) 150. Therefore, the signal processed by the multi-channel PCI sound effect card 140 is processed by the PCI integrated chip or AC-LINK. Then, the signal is transmitted into the digital to analog converter 160 to convert the information from the digital signal to analog signal for human to hear. Each sound channel needs an individual converter. The converted information (multi-channel analog signal) 160 is amplified by an amplifier and then outputs the signal via the speaker or headphone.

The drawback of the technique is too expensive and it is unlikely to be implanted in the main board as built-in sound effect system.

FIG. 2 shows architecture of a conventional main board south bridge built-in two-channel software and hardware. The structure and flow prior to the hardware are similar to the aforementioned prior art. The signal is transmitted to the hardware via the kernel program of an operation system 110 and the sound effect driver 120.

Then, the information received by the hardware is send to the main board south bridge two-channel sound effect hardware 230. The main board south bridge two-channel sound effect hardware 230 includes built-in circuits to provide DMA and AC-LINK format transforming circuits to send the information to a two-channel digital-analog converter AC97 CODEC 240. In general, the AC97 CODEC 240 is directly built-in the main board or is set in the AMR/CNR expand slot defined by Intel. The two-channel analog signal 250 converted by the AC97 CODEC 240 is then output by speaker.

The above system only provides two-channel sound effect, it is unlikely to provide four-channel sound effect to meet the requirement of the user.

Base on the drawbacks of the prior art, the present invention provides architecture to provide four-channel sound effect based on the structure of south bridge two-channel sound effect hardware.

### SUMMARY OF THE INVENTION

The object of the present invention is to allow two-channel sound effect hardware to output four-channel analog signal.

The further object of the present invention is to provide an enhanced sound effect hardware driving means so as to hardware can transmit coded four-channel information.

The yet object according to the present invention is to provide an enhanced CODEC to output four-channel analog signal.

A method allows two-channel hardware sound effect to output four-channel analog signal, comprising:

receiving multiple-channel information by an operation system kernel program;

reducing a frequency of the four-channel to a half for saving bandwidth;

generating a tag in the reduced frequency information;

re-formatting the four-channel so as to allow a two-channel sound effect to process transmitted information;

transmitting the two-channel information into a two-channel sound effect hardware;

transforming the tag for separating four-channel information;

multiplying a frequency of the four-channel information; and

converting the four-channel information to a four-channel analog signal.

An architecture allows two-channel sound effect hardware to output four-channel analog signal, comprising sound effect application program for processing multi-channel information of application software. An operation system kernel program is received the multi-channel information by a multi-channel sound effect interface. Means for transforming a four-channel signal to two-channel signal is coupled to the operation system kernel program to transform a four-channel information to a two-channel information. Two-channel sound effect hardware is coupled to the means for transforming a four-channel signal to two-channel signal. A converter is coupled to the two-channel sound effect hardware to transform the two-channel signal to a four-channel analog signal.

Wherein the means for transforming a four-channel signal to two-channel signal comprises software frequency transformer coupled to the operation system kernel program to reduce a frequency of the four-channel signal to a half for saving the bandwidth. Means for generating tag is coupled to the software frequency transformer to generate a tag in the information under transmitting. Means for formatting is coupled to the means for generating tag to allow said two-channel sound effect hardware to transmit information.

Wherein the converter comprises an information tag transformer coupled to the two-channel sound effect hardware to distinguish front and rear channel, thereby separating four-channel information. A frequency multiplier is coupled to the information tag transformer to multiple the reduced frequency. A digital-to-analog converter is coupled to the frequency multiplier to convert the four-channel information to a four-channel analog information.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is architecture of a conventional high level PCI multiple sound effect software and hardware process flow.

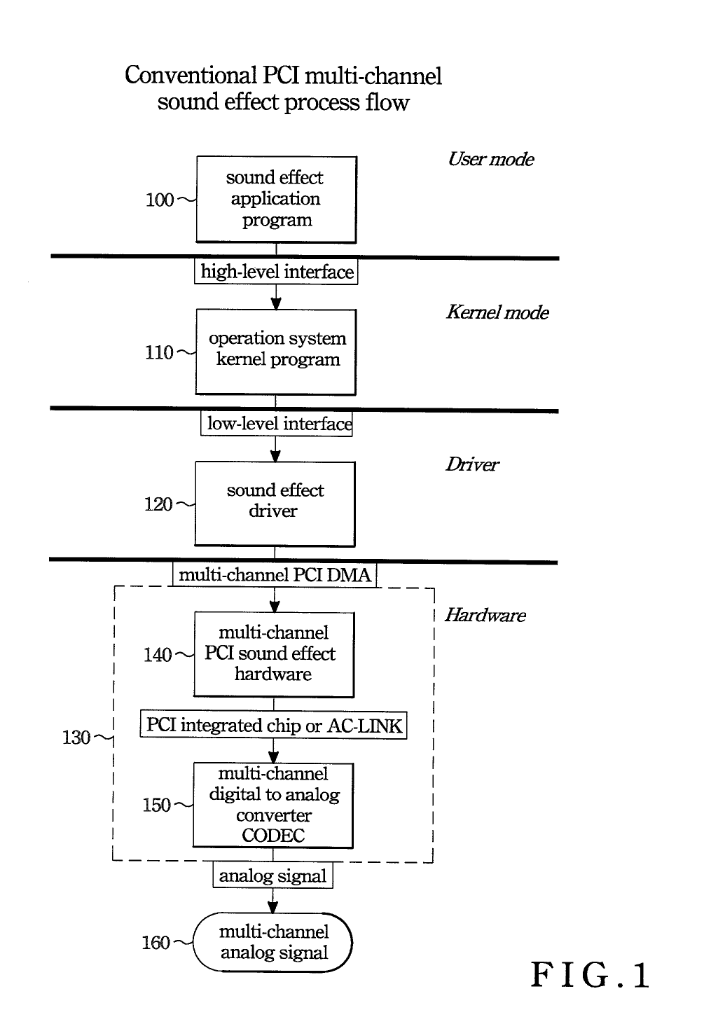

FIG. 2 is architecture of a conventional main board south bridge built-in two-channel sound effect software and hardware process flow.

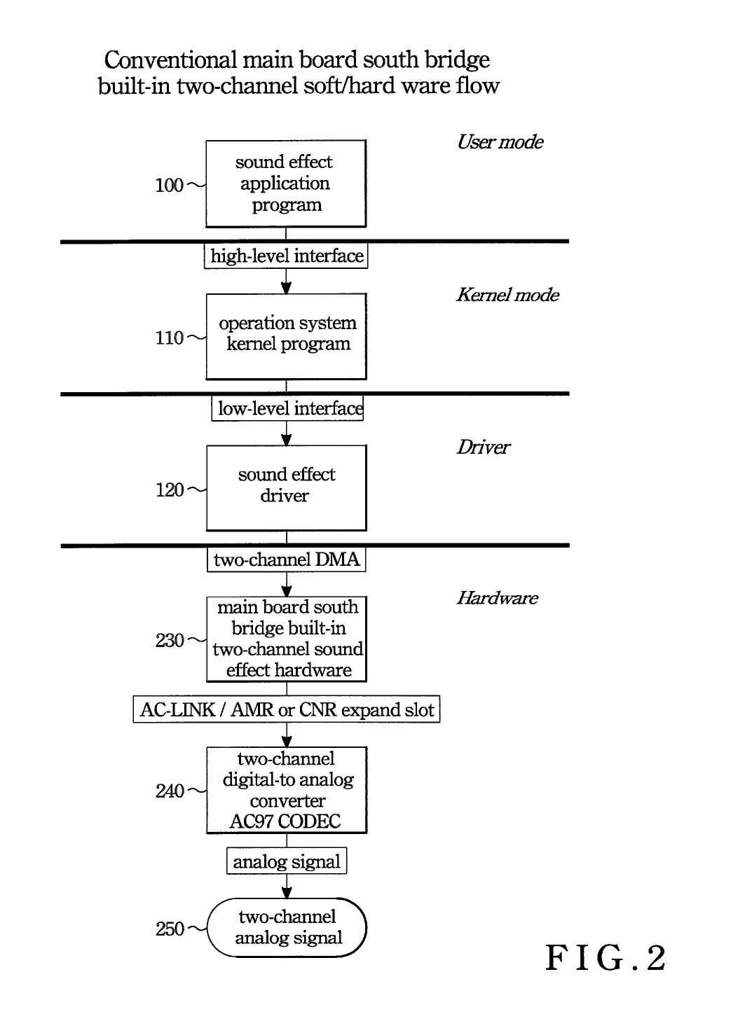

FIG. 3 is architecture of the present invention four-channel enhanced sound effect software and hardware process flow.

FIG. 4 is architecture of the present invention that is implanted in the window operation system.

### THE DETAILED DESCRIPTION OF THE PREFERRED EMBODIMENT

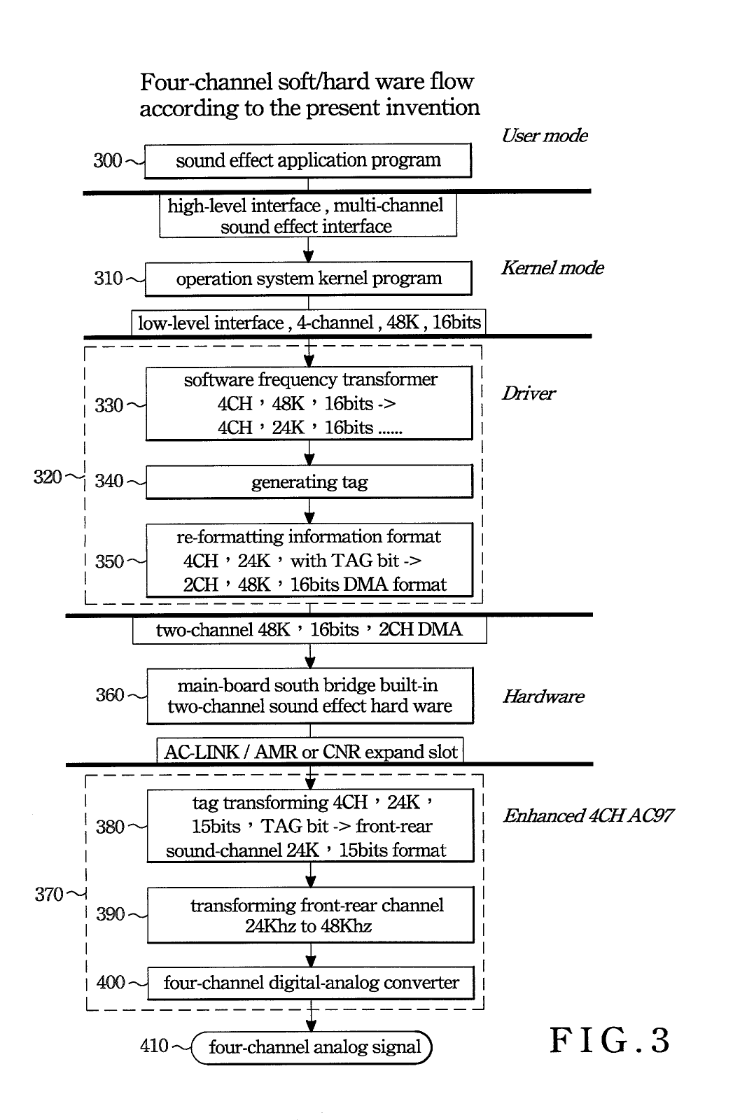

The present invention discloses a method for a south bridge chip with two-channel sound effect to output four-channel sound effect. The present invention provides means for transforming four-channel sound with 48K, 16 bits to two-channel sound with 48K, 16 bits in order to transmit and process the signal by hardware. Further, the present invention provides enhanced means for coding and decoding in order to output four-channel analog signal FIG. 3 shows the architecture diagram according to the present invention. The software user mode includes sound effect application program 300. The user may access the application software and to transmit the sound effect information or signal to the kernel program 310 of the operation system by high level interface, multi-channel sound effect interface. Wherein the application software includes but not limited to 3D game, CD, MP3 playing program or DVD playing software. The operation system herein refers to but not limited to window system of MS, Linux, BeOS and so on. The function of the operation system includes the creation of standard sound effect interface such that the application software may be played in any hardware platform. The enhanced four-channel structure according to the present invention has the capability to process the four-channel sound. The driver will send the related information to operation system to let the operation system transforms the initial multi-sound information to four-channel signal to hardware.

Afterwards, the transformed information includes 48K, 16 bits information is processed by means for transforming a four-channel signal to two-channel signal 320, which may transform the input four-channel information with 48K·16 bits to two-channel information with 48K·16 bits.

Preferably, the means for transforming a four-channel signal to two-channel signal 320 is an enhanced sound effect hardware driver. It includes software frequency transformer 330, means for generating tag or tag generator 340 and means for formatting 350.

In the driver, the enhanced sound effect hardware driver will transmit the signal to let the hardware recognize that the present invention may handle the four-channel sound effect. Thus, the upper layer (operation system) may transmit the 48 KHz four-channel information to the driver. The frequency will be reduced to 24 KHz by software frequency transformer 330 to save the half bandwidth.

Thereafter, a tag is generated in the reduced information by means for generating tag 340. The purpose for the process is to make a mark in the information in order to distinguish the order of the transmitted information, thereby preventing the data from loss. In an embodiment, the tag may be generated in any bit of the front channel or rear channel. Preferably, the tag may be set in the last bit of any channel. The Enhanced AC 97 Tag decoder can distinguish the front and rear channel by the tag in the information. The present invention sacrifices one bit resolution to define a tag, the quality of the sound effect reduces from 96 db to 90 db. The typical PC requires the quality of the resolution is about 85 db, the 90 db quality is still over the requirement of the general PC.

The information format is re-formatted by the usage of means for formatting or formatter 350 after the generation of the tag. Namely, the formatter 350 transforms the format with 24 KHz, four-channel, 15 bits of sound effect and one bit tag information to another format with 48 KHz, two-channel and 16 bits sound effect. The hardware can transmit the encoded four-channel information that is 2CH·48 KHz·16 bits DMA format.

The encoded information is transmitted into the hardware, in a preferred embodiment, the hardware includes but not limited to main board south bridge built-in two channel sound effect hardware 360.

A CODEC 370 decodes aforementioned two-channel signal. Preferably, the CODEC 370 includes but not limited to enhanced four-channel AC97 to act as the decoder. AC97 CODEC can directly built-in the main board of the computer or set in the AMR/CNR expanding slot defined by the Intel.

In the CODEC 370, the information is transformed by the transformer or means for transforming using the tag bit to allow the hardware to distinguish the front and rear channel, thereby separating the four-channel signal, namely, front and rear channel, each with 24 KHz, 16 bits.

Subsequently, hardware frequency multiplier 390 multiple the frequency of the signal from 24 KHz to 48 KHz.

The information transformed by the frequency multiplier 390 is then transformed from four channel digital information to four channel analog information by the usage of four-channel digital-to-analog converter 400. Then, the output device 410 such as speaker or headphone outputs the four channel analog information.

Based on the transformation from 48 KHz to 24 KHz is limited by the bandwidth of the two-channel hardware DMA, the frequency is reduced to obtain four-channel sound effect. However, the quality is acceptable due to the general PC 3D game needs only 22 KHz format. The format with 24 KHz sufficiently meets the requirement of the PC. Besides the hardware will transform the frequency to the initial 48 KHz to minimize the lack of fidelity.

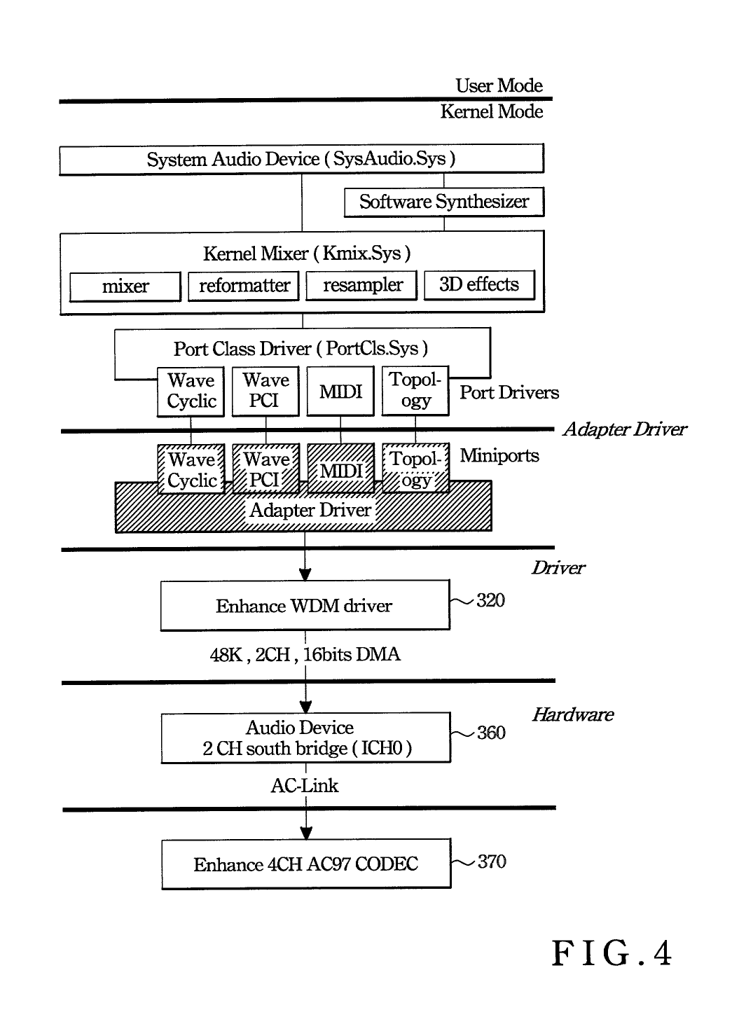

FIG. 4 shows the present invention implanted in the window operation system as an embodiment. As known in the art, the present invention may be implanted any suitable operation system. The enhanced WDM driver according to the present invention is coupled to the adapter driver of the window OS. The enhanced sound effect hardware driving program 320 is coupled to the two-channel south bridge to allow the hardware may transmit four-channel information. The AC97 CODEC 370 decodes the two-channel so as to output four-channel analog signal. The AC97 CODEC may directly built-in the main board or set in the AMR/CNR expanding slot defined by Intel.

As is understood by a person skilled in the art, the foregoing preferred embodiments of the present invention are illustrated of the present invention rather than limiting of the present invention. It is intended to cover various modifications and similar arrangements included within the spirit and scope of the appended claims, the scope of which should be accorded the broadest interpretation so as to encompass all such modifications and similar structure. While the preferred embodiment of the invention has been illustrated and described, it will be appreciated that various changes can be made therein without departing from the spirit and scope of the invention.

What is claimed is:

1. An architecture allows two-channel sound effect hardware to output four-channel analog signal, comprising:
sound effect application program for processing multi-channel information of application software;
operation system kernel program received said multi-channel information by a multi-channel sound effect interface;
means for transforming a four-channel signal to two-channel signal coupled to said operation system kernel program to transform a four-channel signal transmitted by said operation system kernel program to a two-channel signal;
two-channel sound effect hardware coupled to said means for processing said two-channel signal; and
converter coupled to said two-channel sound effect hardware to transform said two-channel signal to a four-channel analog signal.

2. The architecture of claim 1, wherein said means for transforming a four-channel signal to two-channel signal comprising:
software frequency transformer coupled to said operation system kernel program to reduce a frequency of said four-channel signal to a half for saving the bandwidth;
means for generating tag coupled to said software frequency transformer to generate a tag in the information under transmitting; and
means for formatting coupled to said means for generating tag to allow said two-channel sound effect hardware to transmit information.

3. The architecture of claim 1, wherein said converter comprising:
information tag transformer coupled to said two-channel sound effect hardware to distinguish front and rear channel, thereby separating four-channel information;
frequency multiplier coupled to said information tag transformer to multiple said reduced frequency; and
digital-to-analog converter coupled to said frequency multiplier to convert said four-channel information to a four-channel analog information.

4. The architecture of claim 1, wherein said four-channel information includes a format with four-channel, 48 KHz·16 bits.

5. The architecture of claim 1, wherein said two-channel information transformed by said means for transforming a four-channel signal to two-channel signal includes a format with four-channel, 24 KHz·16 bits.

6. The architecture of claim 1, wherein an information after generating said tag therein includes a format with four-channel, 24 KHz·15 bits sound effect and one bit tag information.

7. The architecture of claim 2, wherein an information after formatted by said means for formatting includes a format with two-channel, 48 KHz·16 bits DMA.

8. The architecture of claim 3, wherein an information after transformed by said information tag transformer includes a format with four-channel, 24 KHz·15 bits.

9. The architecture of claim 3, wherein a frequency multiplied by said frequency multiplier is 48 KHz.

10. The architecture of claim 1, wherein said means for transforming a four-channel signal to two-channel signal includes an enhanced sound effect hardware driving program.

11. The architecture of claim 1, wherein said converter includes AC97 CODEC.

12. A method allows two-channel sound effect hardware to output four-channel analog signal, comprising:
receiving a four-channel information by an operation system kernel program;
transforming said four-channel information to a two-channel information;
transmitting said two-channel information into a two-channel sound effect hardware; and
converting said two-channel information to a four-channel analog signal.

13. The method of claim 12, wherein transforming said four-channel information to said two-channel information further comprises:
reducing a frequency of said four-channel to a half for saving bandwidth;
generating tag in said reduced frequency information; and
re-formatting said four-channel so as to allow a two-channel sound effect to process transmitted information.

14. The method of claim 12, wherein said converting said two-channel information to a four-channel analog signal further comprises:
transforming said tag for separating four-channel information;
multiplying a frequency of said four-channel information; and
converting said four-channel information to a four-channel analog signal.

15. The method of claim 12, wherein said four-channel information includes a format with four-channel, 48 KHz·16 bits.

16. The method of claim 12, wherein said two-channel information after transformation includes a format with four-channel, 24 KHz·16 bits.

17. The method of claim 13, wherein an information after generating said tag therein includes a format with four-channel, 24 KHz·15 bits sound effect and one bit tag information.

18. The method of claim 13, wherein an information after re-format includes a format with two-channel, 48 KHz·16 bits DMA.

19. The method of claim 14, wherein an information after said tag is transformed includes a format with four-channel, 24 KHz·15 bits.

20. The method of claim 3, wherein a frequency after multiplied is 48 KHz.

21. A method allow two-channel sound effect hardware to receive four-channel information, comprising:
reducing a frequency of said four-channel information to a half for saving bandwidth;
generating a tag in said reduced frequency four-channel information; and
re-formatting said four-channel so as to allow said two-channel sound effect hardware to process transmitted information.

22. The method of claim 21, wherein said four-channel information includes a format with four-channel, 48 KHz·16 bits.

23. The method of claim 21, wherein a format after reducing frequency includes four-channel, 24 KHz·16 bits.

24. The method of claim 21, wherein an information after generating said tag therein includes a format with four-channel, 24 KHz·15 bits sound effect and one bit tag information.

25. The method of claim 21, wherein an information after re-formatting includes a format with two-channel, 48 KHz·16 bits DMA.

26. The method of claim 21 , further comprising following steps after said two-channel sound effect hardware processing:
transforming said tag for separating four-channel information;
multiplying a frequency of said four-channel information; and
converting said four-channel information to a four-channel analog signal.
